(19) United States
(12) Patent Application Publication
(10) Pub. No.: US 2026/0229475 A1
(43) Pub. Date: Aug. 6, 2026

(54) Method for electrospray ionization mass spectroscopy of multiply-charged biomolecular ions

(71) Applicant: University of Oregon, Eugene, OR (US)

(72) Inventors: James Prell, Eugene, OR (US); Kayd Meldrum, Escondido, CA (US)

(21) Appl. No.: 19/530,181

(22) Filed: Feb. 4, 2026

Related U.S. Application Data
(60) Provisional application No. 63/754,102, filed on Feb. 5, 2025.

(51) Int. Cl. H01J 49/00; H01J 49/16

(52) U.S. Cl. CPC H01J 49/0036; H01J 49/165

(57) ABSTRACT

A method for fully automated deconvolution of electrospray ionization mass spectra of multiply-charged biomolecular ions is disclosed. The method comprises preparing a biomolecular sample and performing mass spectrometry to generate mass spectrum data. This data is processed by a data processor to create a short-time Fourier transform (STFT) spectrogram of frequency versus mass-to-charge (m/z). Signal peaks at integer-value frequencies are grouped, and charge state values are assigned to selected pixels within the spectrogram associated with the grouped series. A preliminary deconvolved mass spectrum is generated via an inverse STFT, followed by an automated refinement process. The refinement includes performing a secondary STFT transform on the preliminary spectrum, excluding signal data at non-integer frequencies, and applying a subsequent inverse STFT to produce absolute mass distribution data. The method facilitates deconvolution of both intact biomolecules and fragment ions produced during gas-phase dissociation.

### CROSS-REFERENCE TO RELATED APPLICATIONS

This application claims priority from U.S. Provisional Patent Application 63/754,102 filed Feb. 5, 2025, which is incorporated herein by reference.

### STATEMENT OF FEDERALLY SPONSORED RESEARCH

None.

### FIELD OF THE INVENTION

The present invention relates generally to mass spectroscopy. More specifically, it relates to methods for electrospray ionization mass spectroscopy.

### BACKGROUND OF THE INVENTION

Electrospray ionization (ESI) mass spectrometry (MS) is an important technique for the analysis and quantification of biomolecules, including proteins and nucleic acid polymers. For the past three decades, electrospray ionization mass spectrometry (ESI-MS) has been the dominant mass spectrometry-based method for determining with high accuracy and precision the masses of biomolecules. As the sensitivity of commercially available mass spectrometers continues to improve and the importance of quantification and detailed analysis of biomolecules from ever more complex mixtures increases, there is a major need for efficient and reliable methods to analyze and interpret ESI-MS mass spectra.

ESI generates a population of ions characterized by a distribution of charge states, which results from the stochastic nature of charge acquisition during droplet evaporation. Consequently, when these ions are analyzed by MS, each biomolecule in a sample is represented within a mass spectrum by a series of related peaks at various mass-to-charge (m/z) ratios. Assigning these peaks involves associating a specific m/z signal with both a particular charge state and a particular mass.

Despite advancements in mass spectrometer sensitivity and online separation techniques like liquid chromatography, ESI mass spectra often contain high degrees of heterogeneity, background signal, and noise. Traditional peak assignment methods often rely on manual analysis or software algorithms that can be highly sensitive to user-selected parameters, such as target mass ranges and bin widths. Furthermore, existing computerized methods may be prone to misassignments of mass or charge and the generation of artifacts, making it difficult to distinguish real analyte signals from computational noise. These challenges are particularly acute in complex mixtures or when analyzing fragment ions produced during gas-phase dissociation.

### SUMMARY OF THE INVENTION

Methods for electrospray ionization mass spectrometry and data processing are provided to produce absolute mass distribution data from biomolecular samples. In one aspect, a method includes preparing a sample solution comprising biomolecules and performing electrospray ionization to produce ionized biomolecules. Mass spectrometry is performed on the ionized biomolecules using a mass spectrometer to generate mass spectrum data. According to various implementations, the mass spectrum data is processed using a data processor to generate a short-time Fourier transform (STFT) spectrogram (e.g., a Gabor spectrogram) of frequency versus m/z. Processing further includes grouping a series of signal peaks, identified as local magnitude maxima, at integer-value frequencies in the STFT spectrogram. Charge state values are assigned to selected pixels in the STFT spectrogram associated with the grouped series of signal peaks. In some embodiments, a preliminary deconvolved mass spectrum is generated by applying an inverse STFT transform to the selected pixels and converting m/z values to mass values using the assigned charge state values. In certain embodiments, the grouping of signal peaks involves identifying a highest-magnitude peak and locating adjacent peaks along a hyperbolic trace in the STFT spectrogram to correspond to a charge state distribution. In other embodiments, the method is directed toward dissociated fragments, where the grouped series corresponds to charge states of isotopically-resolved signal peaks having a common integer frequency.

The preliminary deconvolved spectrum may be refined to produce absolute mass distribution data. In one implementation, refinement is performed by conducting a secondary STFT transform on the preliminary deconvolved spectrum, excluding signal data not centered around non-integer frequencies, and performing a subsequent inverse STFT transform.

The method disclosed enables fully automated deconvolution of biomolecular electrospray ionization mass spectra using short-time Fourier transform techniques, including a refinement technique for removing likely artifacts from the preliminary deconvolved spectrum.

In one aspect, the invention provides a method for electrospray ionization mass spectrometry, including a) preparing a sample solution comprising biomolecules; b) performing electrospray ionization of the sample solution to produce ionized biomolecules; c) performing mass spectrometry of the ionized biomolecules using a mass spectrometer to produce mass spectrum data; and d) processing by a data processor the mass spectrum data to produce in a fully automated manner absolute mass distribution data of the biomolecules. The processing includes i) generating from the mass spectrum data a short time Fourier transform (STFT) spectrogram of frequency versus mass-to-charge (m/z); ii) grouping a series of signal peaks (local magnitude maxima) at integer-value frequencies in the STFT spectrogram; iii) assigning a charge state value to selected pixels in the STFT spectrogram associated with the grouped series of signal peaks; iv) generating a preliminary deconvolved mass spectrum by applying an inverse STFT transform to the selected pixels in the STFT spectrogram associated with the grouped series of signal peaks, and converting m/z values to mass values; and v) refining the preliminary deconvolved spectrum to produce the absolute mass distribution data by performing a secondary STFT transform on the preliminary deconvolved spectrum, excluding signal data at non-integer frequencies, and performing a subsequent inverse STFT transform. Preferably, refinement of the deconvolved spectrum is performed using symmetry and consistency checks around integer frequencies corresponding to unit charge.

In one embodiment, the ionized biomolecules comprise a mixture of proteins of different types, and grouping the series of signal peaks comprises identifying a highest-magnitude peak in the STFT spectrogram and locating peaks along a hyperbolic trace in the STFT spectrogram at integer frequencies adjacent to the highest-magnitude peak, wherein the located peaks correspond to a charge state distribution of a particular analyte.

In another embodiment, the ionized biomolecules comprise dissociated fragments of a single type of protein, and wherein the grouped series of signal peaks correspond to charge states of a plurality of isotopically-resolved signal peaks having a common integer frequency. Preferably, grouping a series of signal peaks comprises grouping pixels of the STFT spectrogram by a common integer-valued frequency corresponding to a charge state. Preferably, assigning the charge state value comprises pre-assigning a likely charge state to each of the plurality of isotopically-resolved signal peaks based on magnitudes observed at the common integer frequency and a plurality of integer multiples of said common integer frequency, and generating the preliminary deconvolved mass spectrum comprises simultaneously applying the inverse STFT transform to all selected pixels assigned to a given charge state across the STFT spectrogram. Preferably, the plurality of isotopically-resolved signal peaks are grouped and assigned charge states based on their shared common integer frequency prior to determining a specific analyte identity or a charge state distribution series for any individual ion.

In another aspect, the invention provides an electrospray ionization mass spectrometer comprising: a) an electrospray ionization source; b) a mass spectrometer; and c) one or more processors configured to perform step (d) of the method above. In yet another aspect, the invention provides a non-transitory computer-readable medium containing executable instructions that cause a processor to perform step (d) of the method above.

### BRIEF DESCRIPTION OF THE DRAWINGS

FIG. 1 is a schematic diagram illustrating an overview of an electrospray ionization mass spectrometry system and method, according to an embodiment of the invention.

FIG. 2 is a flowchart providing an overview of the steps for processing the m/z mass spectrum data to produce absolute mass distribution data, according to an embodiment of the invention.

FIG. 3 is a schematic of a Gabor spectrogram, showing pixels in a frequency vs. m/z plot near a magnitude maximum and how pixels near that magnitude maximum are successively evaluated for inclusion in deconvolution, according to an embodiment of the invention.

FIG. 4A shows raw mass spectrum from a sample containing several biomolecules, according to an embodiment of the invention.

FIG. 4B shows the Gabor spectrogram generated with frequency resolution of 25 data points per unit frequency, according to an embodiment of the invention.

FIG. 4C shows pixels in the Gabor spectrogram assigned charge states through ion-series based searches and magnitude thresholding, according to an embodiment of the invention.

FIG. 4D shows the preliminary deconvolved mass spectrum generated from inverse-Gabor transforming the selected pixels from FIG. 4C, according to an embodiment of the invention

FIG. 5A shows the pre-refinement Gabor spectrogram generated from transforming the preliminary deconvolved spectrum with frequency resolution of 400 data points per unit frequency, according to an embodiment of the invention.

FIG. 5B shows the post-refinement Gabor spectrogram generated from Gabor transforming the refined deconvolved spectrum, according to an embodiment of the invention.

FIG. 5C shows the refined deconvolved spectrum generated from inverse-Gabor transforming the selected signal from FIG. 5A, according to an embodiment of the invention.

FIG. 6A shows a raw mass spectrum from a sample containing ubiquitin, according to an embodiment of the invention.

FIG. 6B shows the Gabor spectrogram generated with frequency resolution of 35 data points per unit frequency, according to an embodiment of the invention.

FIG. 6C shows the results of pixels in the Gabor spectrogram being assigned charge states through magnitude thresholding, according to an embodiment of the invention.

FIG. 6D shows the preliminary deconvolved mass spectrum generated from inverse-Gabor transforming the selected pixels from FIG. 6C one charge state at a time, according to an embodiment of the invention.

FIG. 7A shows a deconvolved spectrum of the isolated ubiquitin 7+ charge state and related CID fragments, according to an embodiment of the invention.

FIG. 7B shows magnified details (upward peaks) of the b₁₇-fragment peaks from FIG. 7A and compares them to peaks expected for this fragment (downward peaks) computationally predicted using natural isotope distributions, according to an embodiment of the invention.

FIG. 7C shows magnified details (upward peaks) of the y₅₉-fragment peaks from FIG. 7A and compares them to peaks expected for this fragment (downward peaks) computationally predicted using natural isotope distributions, according to an embodiment of the invention.

FIG. 7D shows magnified details (upward peaks) of the precursor ion peaks from FIG. 7A and compares them to peaks expected for this ion (downward peaks) computationally predicted using natural isotope distributions, according to an embodiment of the invention.

### DETAILED DESCRIPTION OF THE INVENTION

The following description relates to methods for electrospray ionization mass spectrometry, including the automated deconvolution of mass spectra, particularly those representing multiply-charged biomolecular ions. As used herein, “deconvolution” refers to a process where m/z-domain signals are normalized by their charge state and corrected for charge carrier mass to be recast as a spectrum of abundance versus mass, also referred to as a “zero-charge spectrum”. The term “pixel” refers to an ordered pair (m/z, frequency) in an STFT spectrogram.

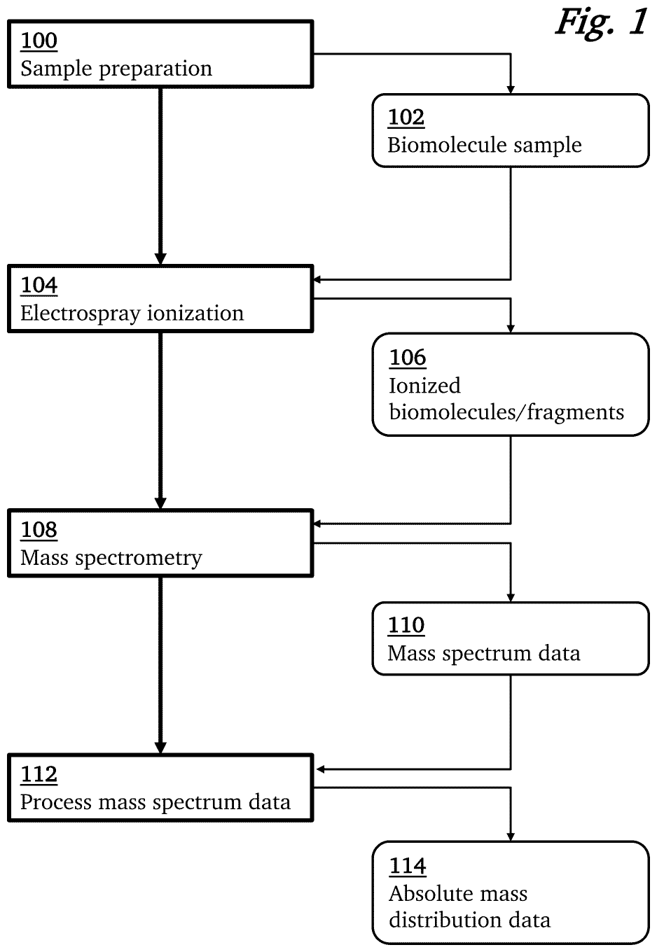

FIG. 1 is a schematic diagram illustrating an overview of an electrospray ionization mass spectrometry system and method, according to an embodiment of the invention. Step 100 includes preparing a biomolecule sample solution 102. For direct infusion ESI, the sample is prepared in a volatile buffer, such as ammonium acetate (typically several hundred nanomolar to several tens of micromolar) at a pH of 6.8-7.4. For online liquid chromatography (LC-ESI), a reverse-phase column with acidified water and acetonitrile is utilized, with a solvent flow rate ensuring elution peaks include at least 10 mass spectrometer scans. In step 104 electrospray ionization of the sample solution 102 produces ionized biomolecules 106. Ionization potentials are set between 0.8-1.5 kV for nano-ESI sources and 1.0-3.5 kV for conventional sources. In certain implementations, particularly those involving gas-phase dissociation, m/z isolation and fragmentation (e.g., Collision Induced Dissociation (CID)) are performed. For CID, a quadrupole may isolate an m/z range of a single charge state, followed by fragmentation in a collision cell with an applied potential of 10-100 V and nitrogen or argon collision gas. Mass spectrum data are acquired across a range sufficient to include multiple charge states of the biomolecules of interest.

In step 108 mass spectrometry of the ionized biomolecules 106 produces mass spectrum data 110 using a mass spectrometer capable of resolving isotopic peaks, such as a time-of-flight (TOF) or Orbitrap instrument. The mass-to-charge (m/z) axis is calibrated using standards spanning the expected range of the analyte.

In step 112 the mass spectrum data 110 is processed to produce absolute mass distribution data 114. In various embodiments, a biomolecular sample is prepared in a volatile buffer and introduced to the mass spectrometer. Mass spectrum data are acquired in an m/z format sufficient to include multiple charge states.

Electrospray ionization 104 of the sample may be performed using a direct infusion electrospray ionization (ESI) source with an electrospray source capillary or an online liquid chromatography-electrospray ionization (LC-ESI) source comprising a liquid chromatograph and a reverse-phase column.

The mass spectrometry 108 may be performed using a mass spectrometer configured to resolve peaks from varying isotope compositions. In many commercial mass spectrometers, electrospray ionization 104 capability is included as part of the instrument. Examples include an Orbitrap mass spectrometer or an Agilent 6545XT quadrupole-time-of-flight mass spectrometer featuring a quadrupole for m/z isolation and a collision cell for performing gas-phase dissociation, such as collision-induced dissociation (CID) using a collision gas like nitrogen. Data processing 112 and acquisition are facilitated by a data processor and a data storage device, also integrated into the mass spectrometer instrument. The data processor is configured to control the instrument, load and store mass spectrum data from digital storage, and process the data. Part of the data processing may also be performed by a processor separate from the instrument.

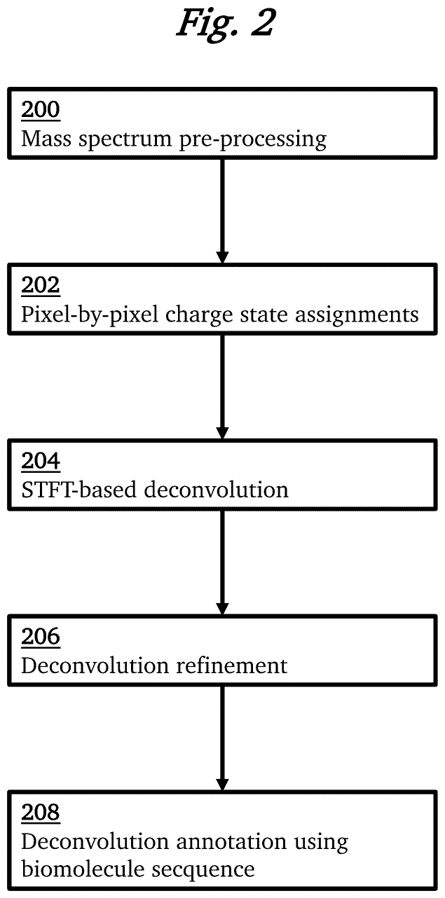

FIG. 2 is a flowchart providing an overview of the steps for processing the m/z mass spectrum data to produce absolute mass distribution data, according to an embodiment of the invention. In step 200, the mass spectrum data is pre-processed. This includes loading and interpolating the data to ensure points are spaced equally along the m/z axis. This may be done, for example, using cubic interpolation to ensure points are spaced equally along the m/z axis. A Fourier Transform is applied, followed by Gaussian smoothing. The Fourier transform is preferably applied such that a sinusoidal signal with a period of 1 along the m/z axis corresponds to a frequency of 1. The Gaussian smoothing preferably uses a standard deviation of 0.5 along the frequency axis.

An appropriate frequency resolution is determined based on the peak with the largest magnitude at a frequency greater than or equal to 3. For example, if the frequency is less than 8, resolution is set to 35 data points per unit frequency. If the frequency is greater than or equal to 8, resolution is set to 25 data points per unit frequency.

Using this resolution, STFT spectrograms (e.g., Gabor spectrograms) are calculated for pixel-by-pixel screening and signal detection. For analyte-directed deconvolution, two Short-Time Fourier Transform (STFT) spectrograms are generated: one at a fraction (e.g., 0.2) of the frequency resolution for initial peak identification, and a second at the full resolution for pixel-by-pixel screening. In fragment-directed embodiments, the STFT window width is rounded to the nearest 10 data points.

In step 202, charge states are assigned, pixel-by-pixel. This involves identifying and tracking maxima, then for each maximum assigning a charge state. For a given maximum, this is performed by screening patterns in the signal, calculating assignment scores, checking symmetry across frequency, estimating baseline and threshold values, and for each pixel, checking for beat frequencies, screen feature shape and previous assignment, assigning a charge state, and screening and assigning harmonics.

In step 204, STFT-based deconvolution is performed. This includes calculating an inverse STFT, correcting for charge, and combining spectra. After applying the inverse-STFT to generate a zero-charge spectrum, pixels assigned a specific charge maintain their value while all others are set to zero. The m/z values are converted to mass using mass=(m/z−massₚᵣₒₜₒₙ)×Z, where Z is the charge state assigned to the pixel. The resulting spectra are interpolated and summed. Data density is restricted to a maximum threshold, which may be selected based on the application, e.g., no more than 40 points per unit Dalton.

In step 206, deconvolution refinement is performed. This includes calculating an STFT of the preliminary deconvolved spectrum with a high frequency resolution (e.g., 400 data points per unit frequency), setting a baseline threshold (e.g., 5-10% of the median magnitude of pixels at frequency 1), and checking symmetry across frequency with a frequency of 1 magnitude threshold. That is, pixels that are not symmetric across a frequency of one or that fall below baseline thresholds are excluded. For frequencies between 0.95 and 1.05, the method identifies maxima for the next ten pixels; if maxima are less than 1% (or less than 5-10%, in some implementations) of the magnitude at frequency 1 and the average relative difference is greater than 80% (Embodiment 1) or greater than 100% (Embodiment 2), the position is excluded.

Next, a test is used to determine whether each peak in the STFT spectrogram of the preliminary deconvolved mass spectrum should be retained or rejected based on the probability of it arising from consecutive vs. non-consecutive charge states of the corresponding analyte. In detail, for each mass bin of the preliminary deconvolved spectrum, the stored contributions of each charge state contributing non-zero signal to that mass bin in the preliminary deconvolution are compared by computing their integrated areas. Charge states are considered to be “consecutive” contributors if they differ by one unit charge and contribute integrated intensities to the particular mass bin that differ by less than a set threshold (5-15% of the largest integrated area). Charge states that do not fit this description are considered possibly non-consecutive. If more than 3 charge states contribute to the preliminary deconvolved spectrum and the majority of them are non-consecutive, the abundance of the refined deconvolved mass spectrum is set to 0 for that mass bin. Otherwise, a threshold value of 100-150% for symmetry of the data along the frequency direction for the given peak in the STFT of the preliminary deconvolved mass spectrum is used to determine whether to include those data in the refined deconvolved mass spectrum. A pixel-by-pixel screening is subsequently performed about the fundamental frequency and higher harmonics of the peak in the STFT spectrogram of the preliminary deconvolved mass spectrum similarly to the screening in step 202. Depending on the implementation and application, pixels are excluded if their magnitude is less than 1% or greater than 90% of the fundamental. Alternatively, pixels are excluded if their magnitude is less than 0.1% or greater than 100% of the fundamental.

A final inverse STFT is performed on the remaining pixels, and the baseline is corrected by subtracting a piecewise-defined line joining negative minima to ensure a non-negative refined mass spectrum. A non-negative baseline is ensured by subtracting a piecewise-defined line joining negative minima, typically identified using a minimum 5-point spacing.

In step 208, for embodiments in which a precursor ion with known biomolecule sequence is fragmented in the gas phase and fragments are detected by the mass spectrometer, annotation of fragment ions is achieved by comparing the masses and relative abundances of peaks in the isotope distributions observed in the preliminary or refined deconvolved mass spectrum to those computed, e.g., from natural isotope distributions, the biomolecule sequence and elemental composition, and well-known gas-phase fragmentation patterns. These theoretical distributions are adjusted in peak width and abundance to match the deconvolved spectrum for visual and numerical validation. Validation of the deconvolved isotope distribution of the biomolecular ion or its fragments may include computing the mass accuracy of major isotope peaks or the average mass and full width at half maximum for the corresponding isotope distribution envelope.

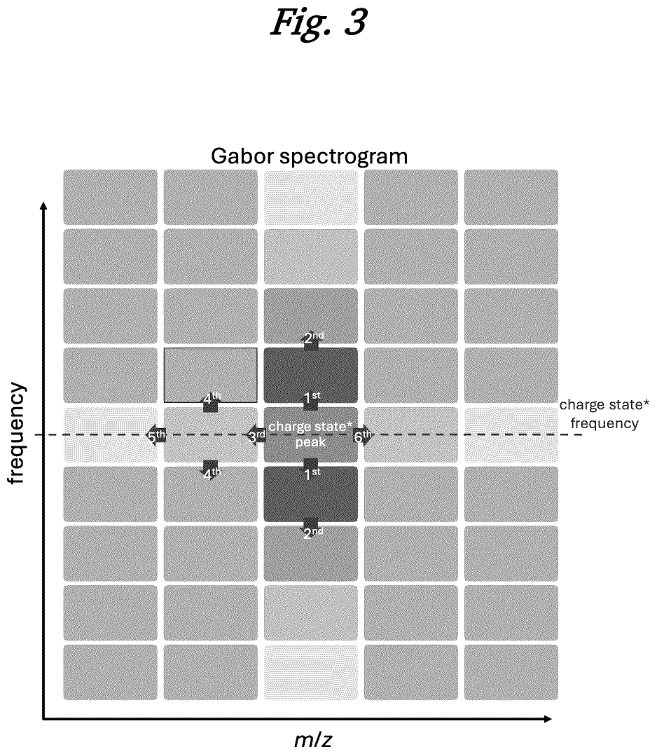

FIG. 3 is a schematic of a Gabor spectrogram, showing pixels in a frequency vs. m/z plot, according to an embodiment of the invention. The schematic illustrates the method of screening pixels as included in step 206 of FIG. 2, discussed above. Following are steps of this screening technique.
1. Screen along frequency, starting at the charge state peak. If the pixel magnitude is less than half the threshold value (defined as the larger of 1-5% of the maximum magnitude above baseline, calculated from the highest-magnitude 5% of pixels at Z+( 1/35) or Z+( 1/25), depending on frequency resolution, and 5-10% of the initial peak magnitude above baseline), then check for beat frequencies or satellite peaks. (Ranges given for these and subsequent threshold values represent various embodiments of the method.) This is achieved by checking the closest maxima between the current frequency and the adjacent integer frequencies, and if the magnitude of either closest-neighbor maximum is less than 70-100% of the threshold, the pixels belonging to the closest-neighbor maxima are determined not to be beat frequencies or satellite peaks and are excluded. A symmetry tolerance, defined as the relative difference of the summed magnitude of data above vs. below the integer frequency associated with the peak, of 70-100% is used.
2. Continue along a column of pixels in the frequency direction until a pixel exceeds the threshold from (1).
3. Proceed to the m/z bin to left of (i.e., at lower m/z than) the current m/z bin. If the pixel magnitude is lower than a set threshold, exclude that m/z bin and all bins further to the left, and proceed to the m/z bin to the right of (i.e., at higher m/z than) the initial pixel belonging to the current peak. Continue to the right until the pixel magnitude is lower than the threshold from (1), at which point that m/z bin and all bins further to the right are excluded.
4. Proceed to the next frequency (i.e., adjacent row of the STFT spectrogram). Frequency is screened symmetrically about the initial frequency as in steps (1) and (2), first proceeding to lower frequency, then to higher frequency.
5. Once all candidate pixels belonging to the STFT spectrogram peak have been identified from steps (1) through (4), the symmetry of the peak along the frequency direction is checked by comparing the magnitudes of the data in pixels equidistant from the center of the peak in the frequency direction (“pixel pairs”) for each m/z bin. If these differ by more than a set threshold (70% for the first embodiment, and 100% for the second embodiment) for a given pixel pair, both pixels in the pair are excluded from the deconvolution.
6. m/z to the right of the charge state peak are screened. It is noted that the term “charge state” is specific to the analyte directed embodiment and is equivalent to “feature” in the charge-state directed embodiment.

The techniques of the present invention have various applications to analysis of biomolecules. Without loss of generality, we now present details of two illustrative embodiments. In a first embodiment, illustrated by the analyte-directed approach, the method focuses on a mixture of biomolecules where each analyte possesses a distribution of charge states. In a second embodiment, the method is adapted for mass spectra resulting from gas-phase dissociation, such as Collision Induced Dissociation (CID), often referred to as “top-down” sequencing. These two embodiments share all the same steps of FIG. 2 but differ primarily in certain specifics of how the pixel-by-pixel charge state assignments (step 202 in FIG. 2) are implemented.

### Analyte-Directed Charge-State Assignment Approach

In a first embodiment, referred to as an analyte-directed approach, a mixture of biomolecules is analyzed where each analyte possesses a distribution of charge states. In this embodiment, the grouping of signal peaks involves identifying a highest-magnitude peak and locating adjacent peaks along a hyperbolic trace in the STFT spectrogram to correspond to a charge state distribution.

In the Pixel-by-Pixel Charge State Assignments 202, local magnitude maxima are identified at integer-value frequencies, ignoring those below the median magnitude and retaining the highest-magnitude 30-50% for further search. For each maximum, an initial mass is estimated by assuming the charge state Z equals the local frequency: mass=(m/z−massₚᵣₒₜₒₙ)×Z. The possible charge range is restricted to 2-55.

The method screens for typical charge series patterns by checking pixel magnitudes potentially assignable to adjacent charge states. The process includes screening along the frequency axis starting at the charge state peak and continuing until a pixel fails a symmetry or magnitude threshold. The screening then proceeds to the next m/z position. Following is an example implementation illustrating details of a charge series screening process. To validate a charge series, the algorithm screens adjacent frequencies and charge states:
Harmonic/Misassignment Check: If Z<6, the search is discarded if an adjacent integer frequency at the same m/z has more than 30-50% of the initial magnitude.
Symmetry and Magnitude Check: Searches are discarded if adjacent charge state positions have magnitudes less than 5-10% of the initial maximum.
Even Charge State Validation: If Z is even, the method compares the average magnitude of three consecutive even charge states to pixels at half those frequencies; if the half-frequency magnitudes are greater, the search is discarded.
Series Score: A score is calculated based on the five most abundant charge states and their second harmonics.
Pixel-by-Pixel Screening Loop: For each charge state, boundaries are defined: ±120 m/z from the initial position and a frequency range of ±1.9. This screening loop includes the following four steps:
1. Baseline Estimation: The baseline is the average magnitude of the lowest 5-15% of pixels across the m/z range.
2. Thresholding: The final threshold is the larger of 1-5% of the maximum

magnitude above baseline (calculated from the highest-magnitude 5% of pixels at Z+( 1/35) or Z+( 1/25), depending on the STFT window size) or 5-10% of the initial peak magnitude above baseline.
3. Symmetry screening: Relative differences in magnitude are calculated for pixel pairs equidistant from the integer frequency. Pixels are excluded if the relative difference exceeds 60-100% and is larger than the preceding pixel.
4. Beat Frequency Check: If pixel magnitude is less than 50-70% of the threshold, the method checks for satellite peaks. If neighboring maxima between the current frequency and the next integer frequency are less than 70-100% of the threshold, the pixels are excluded.

In this embodiment, step 204 includes calculating inverse STFTs for selected data at each assigned charge, converting to mass, and adding together to form a preliminary deconvolved spectrum. Artifacts are removed through a refinement process of step 206 where a secondary STFT of the preliminary spectrum is generated. Symmetry centered about a frequency of one is evaluated to screen for properly corrected charge signal.

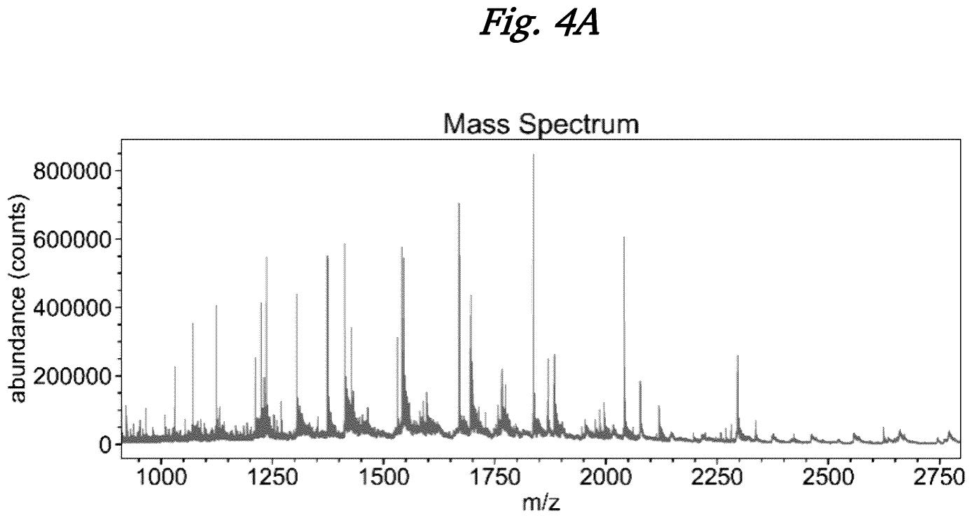

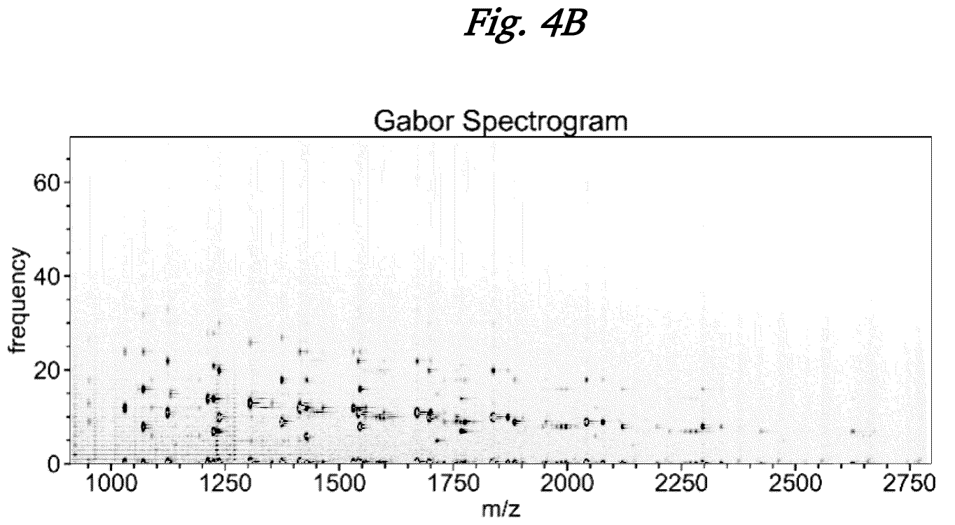

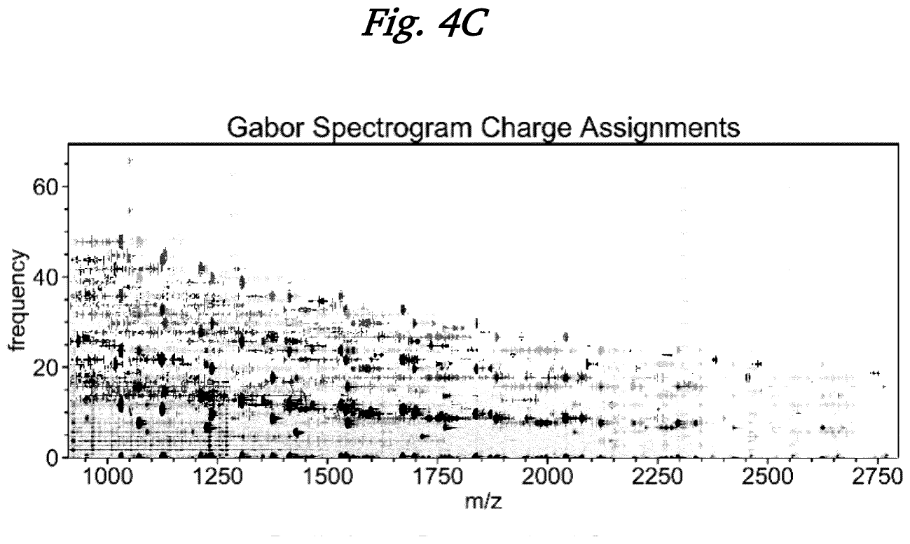

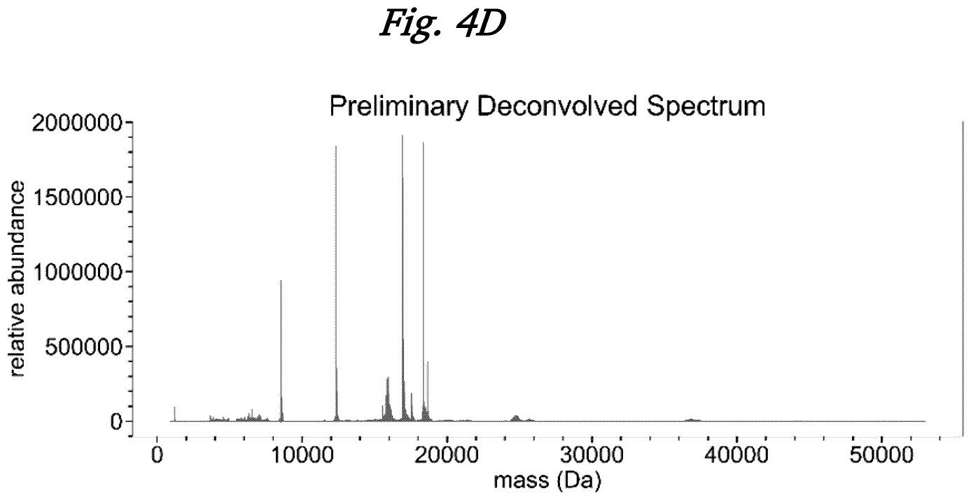

FIGS. 4A-4D are graphs illustrating automatic STFT preliminary deconvolution, according to an embodiment of the invention. FIG. 4A shows a raw mass spectrum from a sample containing several biomolecules. Specifically, this mass spectrum contained signal from five protein standards: ubiquitin, cytochrome c, avidin monomer, myoglobin, and beta-lactoglobulin. The mass spectrum data were obtained via direct infusion and electrospray ionization on a Q-TOF mass spectrometer. FIG. 4B shows the Gabor spectrogram generated with frequency resolution of 25 data points per unit frequency. FIG. 4C shows pixels in the Gabor spectrogram assigned charge states through ion-series based searches and magnitude thresholding. FIG. 4D shows the preliminary deconvolved mass spectrum generated from inverse-Gabor transforming the selected pixels from FIG. 4C one charge state at a time, correcting the x-axis for charge, and adding across the corrected charge states. Note, the spectrum was made non-negative for illustrative purposes.

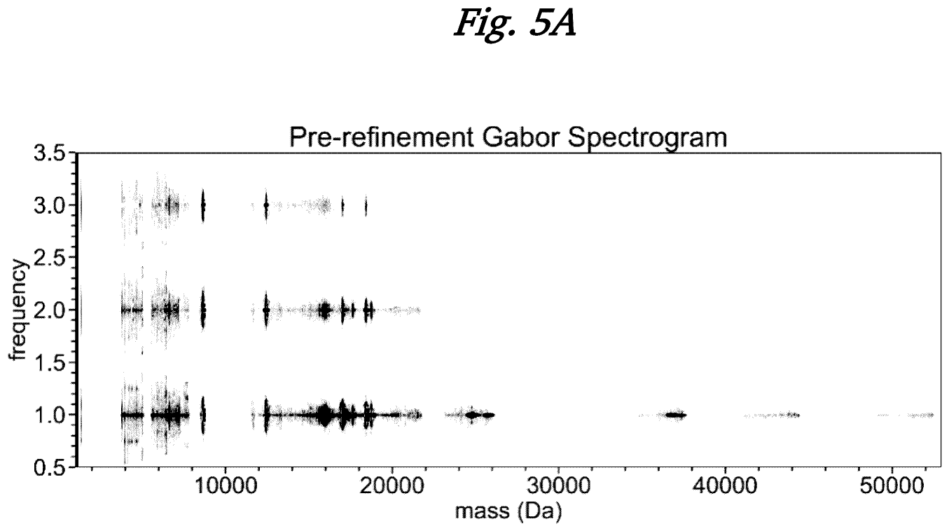

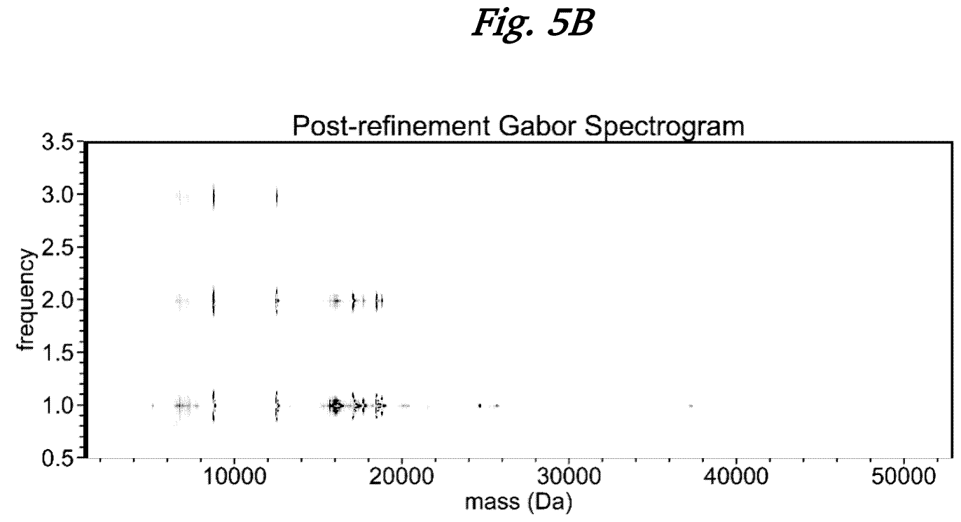

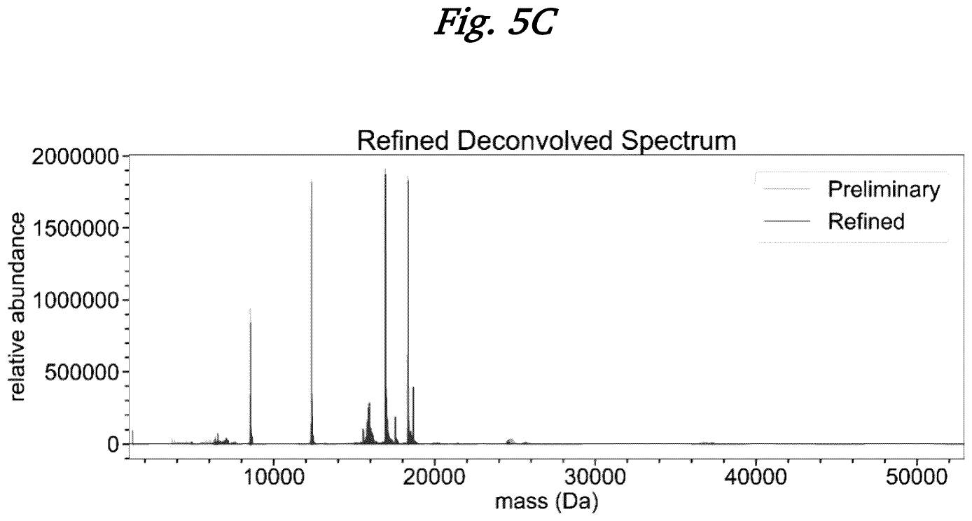

FIGS. 5A-5C illustrate automatic STFT deconvolution refinement, according to an embodiment of the invention. FIG. 5A shows the pre-refinement Gabor spectrogram generated from transforming the preliminary deconvolved spectrum with frequency resolution of 400 data points per unit frequency. FIG. 5B shows the post-refinement Gabor spectrogram generated from Gabor transforming the refined deconvolved spectrum and shows the signal that passed the refinement process (i.e., selected from the pre-refinement Gabor spectrogram). FIG. 5C shows the refined deconvolved spectrum generated from inverse-Gabor transforming the selected signal from FIG. 5A and baseline corrected by subtracting a piecewise-defined line joining adjacent signal minima. The refined deconvolved spectrum was superimposed on the preliminary deconvolved spectrum to emphasize the results of the refinement process.

### Charge-State Directed (Top-Down) Assignment

In a second embodiment, the method is adapted for mass spectra resulting from gas-phase dissociation, such as Collision Induced Dissociation (CID), often referred to as “top-down” sequencing. In this embodiment, the method is directed toward dissociated fragments, where the grouped series corresponds to charge states of isotopically-resolved signal peaks having a common integer frequency.

Step 202 of this embodiment pre-assigns charge states to isotopically-resolved signals with the same frequency, facilitating the deconvolution of fragments with few charge states. The most likely charge state (Z) is determined based on magnitudes at integer multiples of the feature frequency. This allows for the simultaneous deconvolution of all ions with the same charge state. The method assigns the most likely Z based on the average magnitude at the fundamental frequency and the next three harmonics. Specific adjustment logic is applied: If Z equals 1, the method compares summed magnitudes of all pixels belonging to the STFT spectrogram peak (i.e., the integrated peak magnitude) at frequencies 3 and 5 versus 2, 4, and 6. If the integrated peak magnitude at frequency 3 is less than two times the integrated peak magnitude at frequency 2, then Z is updated to 2. If Z equals 2 and the integrated peak magnitude at frequency 3 is more than two times the integrated peak magnitude at frequency 2, then Z is updated to 1. If integrated peak magnitudes at frequencies that are multiples of 4 are significantly higher than at other even frequencies, Z is set to 4.

For features where Z is greater than 6, the method checks if the feature was previously assigned as a harmonic (one-half or one-third frequency). Assignments are kept only if the harmonic magnitude is significantly lower (e.g., less than 0.5 or less than 0.2) than the fundamental. Pixels are screened within 6-12 m/z bins of the initial position. Symmetry screening uses 90-100% of the magnitude below the feature frequency to account for trends toward greater magnitude at lower frequencies.

In step 208 of this embodiment, theoretical isotope distributions are calculated using the expected precursor biomolecule sequence. These theoretical distributions are adjusted in peak width and abundance to match the deconvolved spectrum for visual and numerical validation of fragment ion identifications. Distributions for fragments are generated by truncating the sequence at cleavage sites and adjusting elemental composition. For visual validation, theoretical distributions are convolved with a Gaussian to match the experimentally observed peak widths and abundances in the refined deconvolved spectrum. Additionally, the isotope-resolved peaks are smoothed with a Gaussian (standard deviation of 0.8 Da) to compare the average masses of the theoretical and experimental distributions.

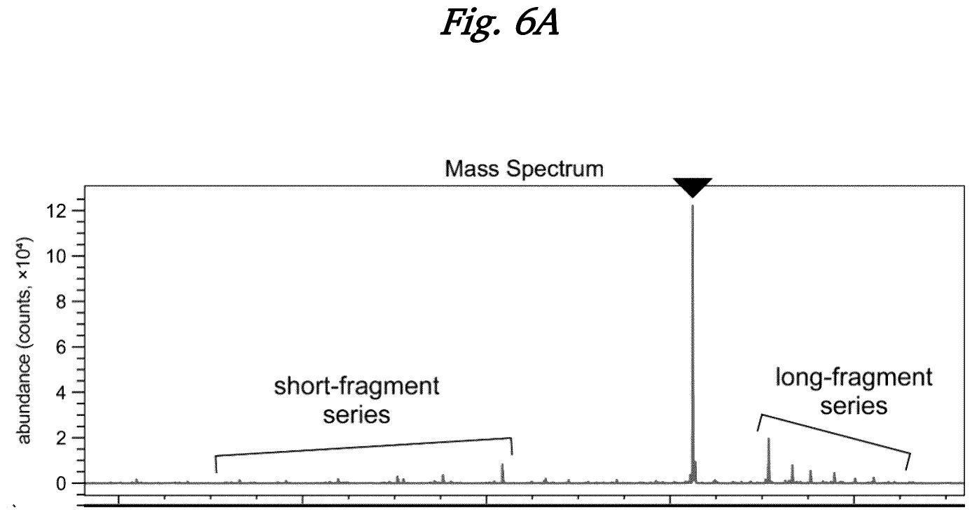

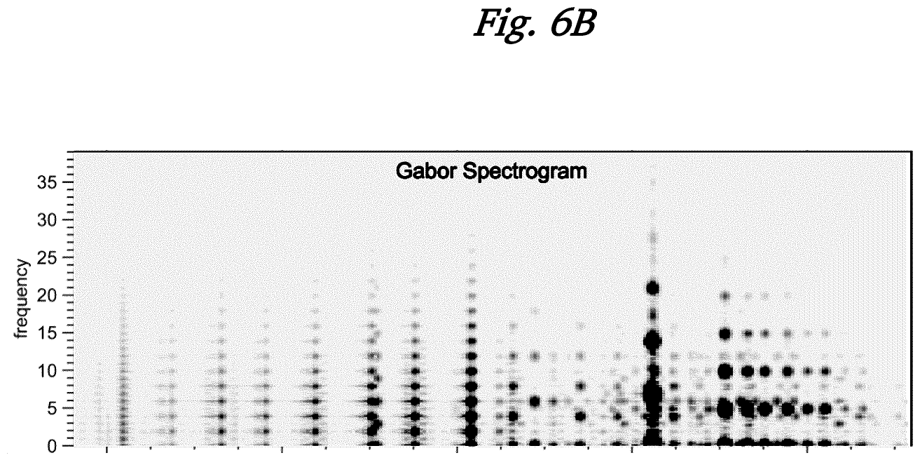

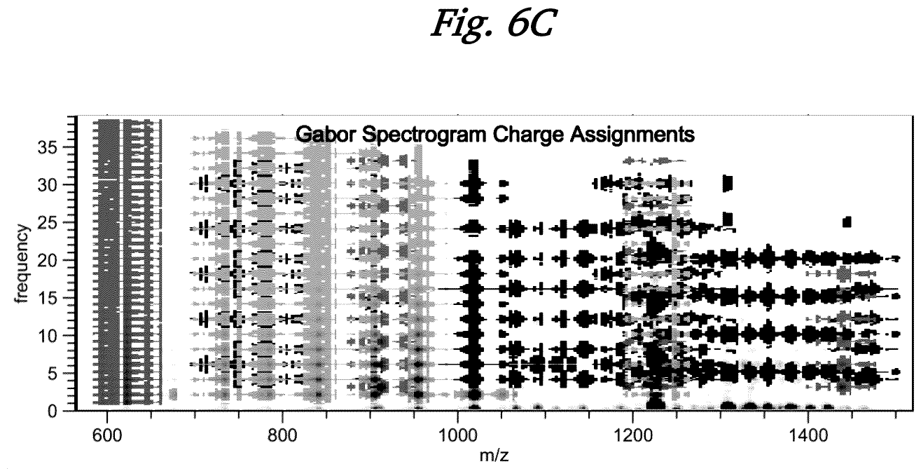

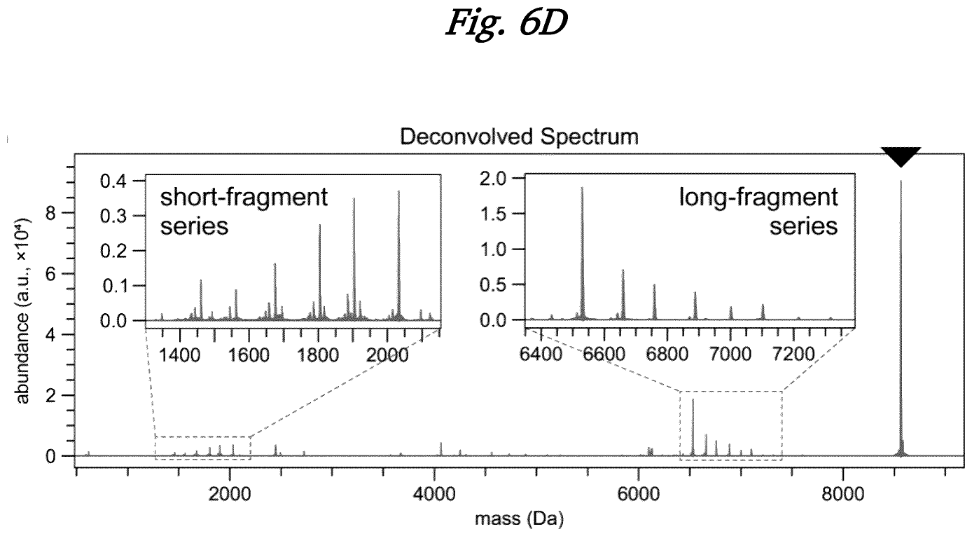

FIGS. 6A-6D illustrate automatic STFT preliminary deconvolution of ubiquitin (UBQ) 7+ signal and related CID fragments, according to an embodiment of the invention. FIG. 6A shows a raw mass spectrum from a sample containing ubiquitin. Specifically, this mass spectrum was acquired via inline liquid chromatography and electrospray ionization on a Q-TOF mass spectrometer with isolation of the UBQ 7+ charge state and subsequent fragmentation by CID. The precursor peak (UBQ 7+) was labeled with a triangle, and the major groups of fragments were labeled by relative size. FIG. 6B shows the Gabor spectrogram generated with frequency resolution of 35 data points per unit frequency. FIG. 6C shows the results of pixels in the Gabor spectrogram being assigned charge states through magnitude thresholding. FIG. 6D shows the preliminary deconvolved mass spectrum generated from inverse-Gabor transforming the selected pixels from FIG. 6C one charge state at a time, correcting the x-axis for charge, and adding across the corrected charge states. Similar to FIG. 6A, the precursor peak (charge-corrected UBQ 7+) was labeled with a triangle, and the major groups of fragments were labeled by relative size. Note, the spectrum was made non-negative for illustrative purposes.

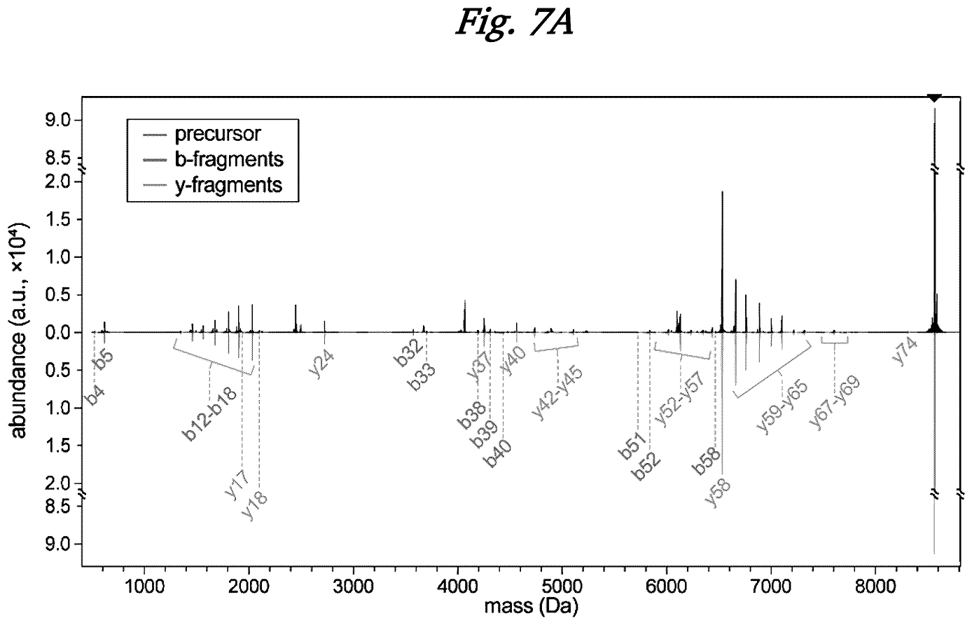

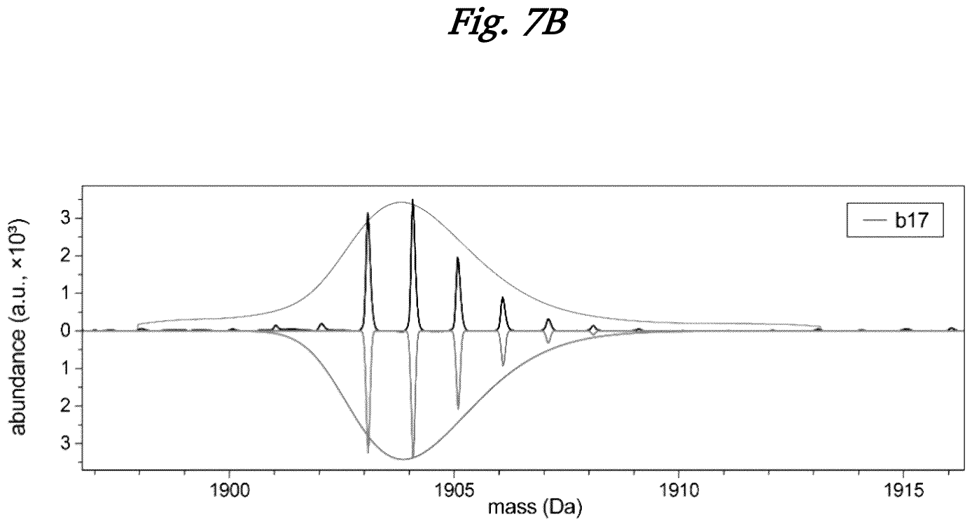

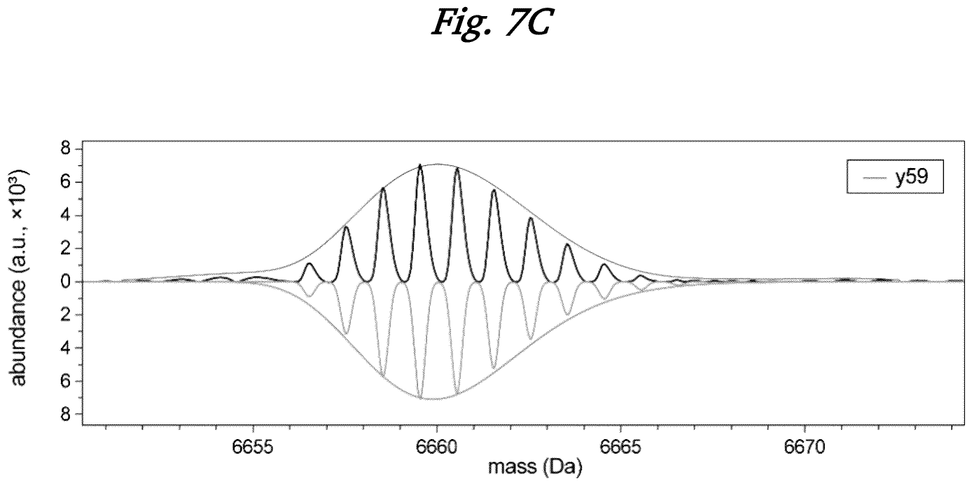

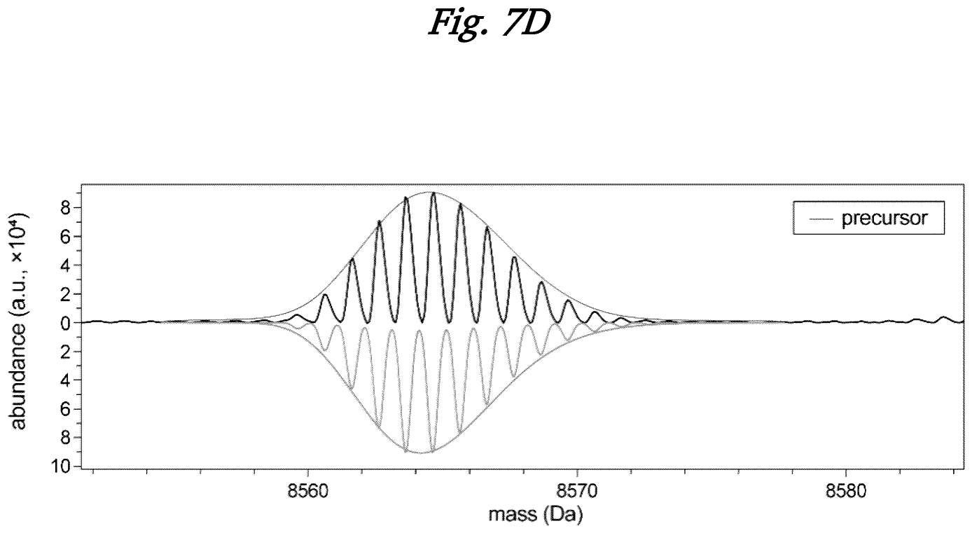

FIGS. 7A-7D illustrate deconvolved spectrum peak assignments based on theoretical isotope distributions calculated from amino acid sequence, according to an embodiment of the invention. FIG. 7A shows a deconvolved spectrum of the isolated ubiquitin 7+ charge state and related CID fragments. Theoretical isotope distributions were plotted with abundances and peak widths fit to match the corresponding peaks in the deconvolved spectrum. FIGS. 7B-7D show zoom-ins on the b₁₇-fragment peaks, y₅₉-fragment peaks, and the precursor peaks, respectively. The average mass peaks, plotted on top of the isotope distributions, were calculated by Gaussian convolution with a standard deviation of 0.8 Da.

1. A method for electrospray ionization mass spectrometry, comprising:
a) preparing a sample solution comprising biomolecules;
b) performing electrospray ionization of the sample solution to produce ionized biomolecules;
c) performing mass spectrometry of the ionized biomolecules using a mass spectrometer to produce mass spectrum data; and
d) processing by a data processor the mass spectrum data to produce in a fully automated manner absolute mass distribution data of the biomolecules, wherein processing comprises:
i) generating from the mass spectrum data a short time Fourier transform (STFT) spectrogram of frequency versus mass-to-charge (m/z);
ii) grouping a series of signal peaks (local magnitude maxima) at integer-value frequencies in the STFT spectrogram;
iii) assigning a charge state value to selected pixels in the STFT spectrogram associated with the grouped series of signal peaks;
iv) generating a preliminary deconvolved mass spectrum by applying an inverse STFT transform to the selected pixels in the STFT spectrogram associated with the grouped series of signal peaks, and converting m/z values to mass values; and
v) refining the preliminary deconvolved spectrum to produce the absolute mass distribution data by performing a secondary STFT transform on the preliminary deconvolved spectrum, excluding signal data at non-integer frequencies, and performing a subsequent inverse STFT transform.

2. The method of claim 1 wherein refinement of the deconvolved spectrum is performed using symmetry and consistency checks around integer frequencies corresponding to unit charge.

3. The method of claim 1, wherein the ionized biomolecules comprise a mixture of proteins of different types, and wherein grouping the series of signal peaks comprises identifying a highest-magnitude peak in the STFT spectrogram and locating peaks along a hyperbolic trace in the STFT spectrogram at integer frequencies adjacent to the highest-magnitude peak, wherein the located peaks correspond to a charge state distribution of a particular analyte.

4. The method of claim 1, wherein the ionized biomolecules comprise dissociated fragments of a single type of protein, and wherein the grouped series of signal peaks correspond to charge states of a plurality of isotopically-resolved signal peaks having a common integer frequency.

5. The method of claim 4 wherein grouping a series of signal peaks comprises grouping pixels of the STFT spectrogram by a common integer-valued frequency corresponding to a charge state.

6. The method of claim 4, wherein assigning the charge state value comprises pre-assigning a likely charge state to each of the plurality of isotopically-resolved signal peaks based on magnitudes observed at the common integer frequency and a plurality of integer multiples of said common integer frequency, and wherein generating the preliminary deconvolved mass spectrum comprises simultaneously applying the inverse STFT transform to all selected pixels assigned to a given charge state across the STFT spectrogram.

7. The method of claim 4, wherein the plurality of isotopically-resolved signal peaks are grouped and assigned charge states based on their shared common integer frequency prior to determining a specific analyte identity or a charge state distribution series for any individual ion.

8. An electrospray ionization mass spectrometer comprising:
a) an electrospray ionization source;
b) a mass spectrometer; and
c) one or more processors configured to perform step (d) of claim 1.

9. A non-transitory computer-readable medium containing executable instructions that cause a processor to perform step (d) of claim 1.
